(19) United States
(12) Patent Application Publication
(10) Pub. No.: US 2002/0095393 A1
(43) Pub. Date: Jul. 18, 2002

(54) Computer program for and method of discrete event computer simulation incorporating biological paradigm for providing optimized decision support

(76) Inventor: Roger McHaney, Manhattan, KS (US)

Correspondence Address: THOMAS B. LUEBBERING, HOVEY, WILLIAMS, TIMMONS & COLLINS, Suite 400, 2405 Grand, Kansas City, MO, 64108, US

(21) Appl. No.: 09/875,058

(22) Filed: Jun. 6, 2001

Related U.S. Application Data
(60) Provisional application No. 60/209,669, filed on Jun. 6, 2000.

(51) Int. Cl. G06N 3/00; G06N 3/12; G06F 15/18

(52) U.S. Cl. 706/13; 703/11

(57) ABSTRACT

A computer program for and method of discrete event computer simulation incorporating a biological paradigm, wherein the simulation provides decision support and the biological paradigm contributes optimization of the simulation such that the invention is able to devise and test its own potential solutions to a given problem. The biological paradigm or genetic algorithm is based upon the mechanics of natural selection and population genetics, combining machine-learning with the principle of “survival of the fittest”, including such biological concepts such as reproduction, crossover, and mutation. Potential uses include a programming language preprocessor; a simulation language preprocessor; and an embedded component providing decision support for controlling a system or process.

### RELATED APPLICATIONS

This application is related to and claims priority benefit of a provisional application titled “Genetic Algorithm Implementation in Discrete Event Computer Simulation”, Serial No. 60/209,669, filed Jun. 6, 2000. The identified provisional application is hereby incorporated by reference.

### COMPUTER PROGRAM LISTING APPENDIX

A computer program listing appendix containing the source code of a computer program that may be used with the present invention is incorporated herein by reference and appended hereto as one (1) original compact disk, and an identical copy thereof, containing a total of five (5) files as follows:

| Filename | Date of Creation | Size (Bytes) |
|---|---|---|
| 900951.DAT | 06/04/01 02:59a | 10,502 |
| 900951.PAR | 06/04/01 02:59a | 5,732 |
| 900951.QAR | 06/04/01 02:59a | 1,001 |
| BP.SIM | 06/04/01 09:10a | 10,538 |
| USER.SIM | 06/04/01 02:59a | 249,843 |

### BACKGROUND OF THE INVENTION

1. Field of the Invention

The present invention relates to computer programs for and methods of discrete event computer simulation for providing decision support. More particularly, the invention relates to a computer program for and method of discrete event computer simulation incorporating a biological paradigm based upon the mechanics of natural selection and population genetics, wherein the simulation provides decision support and the biological paradigm contributes optimization of the simulation such that the invention is able to devise its own solutions to a given problem rather than merely test or model human-devised solutions.

2. Description of the Prior Art

It is often desirable to use computerized decision support tools to test a pool of potential solutions to a problem prior to choosing, investing in, and committing to a particular potential solution. For example, in an increasingly complex corporate environment, computerized decision support tools are used to decipher vast amounts of available data and apply the results in a manner that maximizes competitive advantage and economic gain.

It is known to use computer simulation as a decision support tool, wherein the computer simulation models a system or process in such a manner that the model mimics the response of an actual system to events that take place over time. The basic premise of computer simulation concerns abstractions, simplifications, and approximations to model or describe the process or system of interest. Typically, when constructing a simulation model, observations are made of the behavior of the actual system and pseudo-random input parameters are drawn from specific distributions and logical relationships to form the model. In many cases, simulation models rely on an analyst to specify probability distributions used as inputs to represent the time between events or durations of events. These distributions are often based upon pseudo-random number generators built into the simulation language. Once complete, the simulation model is run and evaluated over time through data collection and statistical interpretation to estimate the actual system's true output response. Because model inputs are stochastic, output from any particular simulation run is a single observation and must be interpreted statistically. This is accomplished by statistically removing model start-up bias, replicating runs, and creating confidence intervals to describe output values.

Discrete event computer simulation is a specific modeling technique characterized by the passage of discrete blocks of time during which no changes to the system state occur. When they occur, such changes take place instantly and in countable increments in response to sudden or discrete events or occurrences. Traditionally, discrete event computer simulation has been used in the development of descriptive or representational studies. Because discrete event computer simulation also produces pseudo-random estimates of a model's true characteristics, several independent simulations are required for each set of input parameters studied.

For these reasons, simulation models are often used in the comparison of scenarios based upon variable input parameters rather than in optimization studies. The search for methodologies to adapt simulation to applications requiring optimization has been dominated by various statistical and mathematical techniques. While providing some relief, these techniques have not been uniformly accepted and simulation remains largely a descriptive tool or a tool used for comparison of alternative system configurations.

Thus, given a problem, it is possible to simulate or model a number of identified potential solutions and evaluate their anticipated and unanticipated effects prior to selecting, investing in, and committing to a particular potential solution. Unfortunately, conventional simulations are able to test only human-provided potential solutions, thereby severely limiting the pool of potential solutions from which the optimum potential solution is ultimately selected. Furthermore, each change in input parameters must be redundantly and inefficiently tested with several independent runs.

Due to these and other problems and disadvantages in the art, an improved computer program for or method of discrete event computer simulation is needed.

### SUMMARY OF THE INVENTION

The present invention overcomes the above-described problems and disadvantages to provide a distinct advance in the art of computerized decision support tools. More particularly, the present invention is a computer program for and method of discrete event computer simulation incorporating a biological paradigm, wherein the simulation provides decision support and the biological paradigm contributes optimization of the simulation such that the invention is able to devise and test its own potential solutions.

The biological paradigm is based upon the mechanics of natural selection and population genetics, combining machine-learning with the principle of “survival of the fittest”. Thus, the biological paradigm is a computational model of biological evolution, working with populations of solutions and guiding a search for improvement through the fitness principle. Each potential solution is evaluated in light of an objective fitness function and then, as appropriate, either terminated or deemed eligible to propagate. Biological concepts of reproduction, crossover, and mutation are employed such that, over time, stochastic processes encourage the fittest solutions to emerge. Thus, unlike existing simulations or models which are limited merely to testing human-provided potential solutions, the present invention is able to devise and test its own potential solutions.

Similar biological paradigms have been widely used in a variety of applications, including multi-parameter optimization, classification, evolution of computer programs and computational structures in machine learning, modeling organizational change, and simulation of cognitive systems.

In a preferred embodiment, the biological paradigm is provided in generic form fully compatible with standard discrete event computer simulations and adapted to facilitate easy integration therewith. Thus, a third-party, having devised a discrete event computer simulation for investigating potential solutions to a particular problem, can obtain and easily integrate the generic biological paradigm to enhance the simulation with an ability to both devise and test potential solutions. The third-party need only provide control parameters for controlling functioning of the paradigm, and input parameters defining the particular model. For example, where the problem involves control and navigation of an automated vehicle from one point to another within a factory, as in Example 2, set forth below in the section titled DETAILED DESCRIPTION OF A PREFERRED EMBODIMENT, the control parametersmayincludemaximumnumberofgenerationsandrulesforpropagation, and the input parameters may include layout of the factory floor, possible paths available, and locations of obstacles.

Uses for the present invention include a programming language preprocessor; a simulation language preprocessor; and an embedded component for decision support in controlling a system or process. The programming language preprocessor embodiment can be developed using any suitable programming language, including Java, C, C++, or FORTRAN. The programming language-based biological paradigm is used to generate a database that provides input to the computer simulation. Potential uses for the preprocessor include, for example, development of job shop schedules used to drive a model, airport runway allocations, human decision-making based upon a set of known criteria, classroom scheduling, and bus routing.

Similarly, the simulation language preprocessor embodiment can be developed using any suitable simulation language as an implementation medium for a preprocessor. The simulation language-based biological paradigm is used to generate a database of tested solutions that provide input to the model as needed. Suitable simulation languages include GPSS/H, SIMAN IV, and SLAM, which include facilities for implementing the logical requirements of a biological paradigm. Example 1, set forth below in the section titled DETAILED DESCRIPTION OF A PREFERRED EMBODIMENT, is an illustrative example of the simulation language preprocessor embodiment wherein the present invention is used to find the shortest distance between two points.

The embedded component embodiment takes the simulation-based biological paradigm preprocessor a step farther by embedding code in a broader-scale simulation model. The code is used to generate data items on an as-needed basis. When a particular decision based upon a set of stochastically-generated circumstances within the model is required, the biological paradigm is called into action. Example 2 is an illustrative example of the embedded component embodiment. It will be appreciated that Example 2 involves a practical application of the simulation preprocessor disclosed in Example 1.

These and other important aspects of the present invention are more fully described in the section entitled DETAILED DESCRIPTION OF A PREFERRED EMBODIMENT, below.

### BRIEF DESCRIPTION OF THE DRAWINGS

A preferred embodiment of the present invention is described in detail below with reference to the attached drawing figures, wherein:

FIG. 1 is a flow diagram showing steps for practicing a preferred embodiment of the present invention;

FIG. 2 is a flow diagram showing the processes of reproduction and crossover in a preferred embodiment of the present invention;

FIG. 3 is an operation grid square used in Example 1, wherein Example 1 illustrates a preferred embodiment of the present invention;

FIG. 4 is a data table setting forth data associated with Example 1;

FIG. 5 is a graph of population fitness data associated with Example 1;

FIG. 6 is a first operation grid square used in a first scenario of Example 2, wherein Example 2 illustrates a preferred embodiment of the present invention;

FIG. 7 is a second operation grid square used in a second scenario of Example 2;

FIG. 8 is a first data table setting forth data associated with the first scenario of Example 2; and

FIG. 9 is a second data table setting forth data associated with the second scenario of Example 2.

### DETAILED DESCRIPTION OF THE PREFERRED EMBODIMENT

The present invention is a computer program for and method of discrete event computer simulation incorporating a biological paradigm based upon the mechanics of natural selection and population genetics, wherein the simulation provides decision support and the biological paradigm contributes optimization of the simulation such that the invention is able to devise and test its own potential solutions to a given problem.

Computer simulation and, more particularly, discrete event computer simulation is well-known, and the present invention is independent of any particular simulation or input parameters. Those with ordinary skill in the art will appreciate that computer simulation is used as a decision support tool to model, using abstractions, simplifications, and approximations, a system or process in such a manner that the model mimics the response of the actual system to events that take place over time.

Typically, when constructing a simulation model, observations are made of the behavior of the actual system and pseudo-random input parameters are drawn from specific distributions and logical relationships to form the model. In many cases, simulation models rely on an analyst to specify probability distributions used as inputs to represent the time between events or durations of events. These distributions are often based upon pseudo-random number generators built into the simulation language. Once complete, the simulation model is run and evaluated over time through data collection and statistical interpretation to estimate the actual system's true output response.

For example, given a corporation for which non-maximized profit is a problem, it may be desirable to enact changes to increase efficiency or take other steps to maximize profits. It may also be desirable, however, to investigate the effects of any potential changes prior to investing in and committing to them. A computer simulation of the corporation, or some relevant portion or aspect thereof, allows for testing each potential change by varying corresponding input parameters, such as, for example, spending, advertising, inventory, manufacturing capacity, storage capacity, shipping capacity, and employee numbers and salaries. Various adaptable corporate models exist or may be created as desired.

The discrete event computer simulation of the present invention is a well-known modeling technique characterized by the passage of discrete blocks of time during which no changes to the system state occur. When they occur, changes to the system state take place instantly and in countable increments in response to sudden or discrete events or occurrences. In the present invention, the discrete event computer simulation may be constructed using any suitable simulation language, including, for example, GPSS/H, SIMAN IV, and SLAM, all of which include facilities for implementing the logical requirements of the biological paradigm. Furthermore, the discrete event computer simulation may be executable by any suitable computing device, such as a conventional personal computer or main frame, and stored on any suitable computer-readable memory, such as an optical or magnetic memory, including, for example, a hard drive, a CD-ROM, or a floppy disk.

The biological paradigm or genetic algorithm of the present invention is a model of biological evolution, using generations or populations of potential solutions to guide a search for improvement based upon the mechanics of natural selection and population genetics, combining machine-learning with the principle of “survival of the fittest”. Artificial “creatures” are created in software and stored and manipulated in computer memory, wherein each artificial creature represents a potential solution comprising a data structure of binary encoded input parameters.

Broadly, the biological paradigm involves three major steps. First, an initial (or first or “parent”) generation or population of solutions is randomly created. Next, the fitness of each potential solution of the current generation is evaluated using an objective fitness test; variations in each potential solution result in varying degrees of fitness. Lastly, the fitter solutions are propagated to form a “child” or second generation. The process is repeated, with each new generation being evaluated for fitness, until a stop condition occurs, such as identification of an optimal or fittest solution.

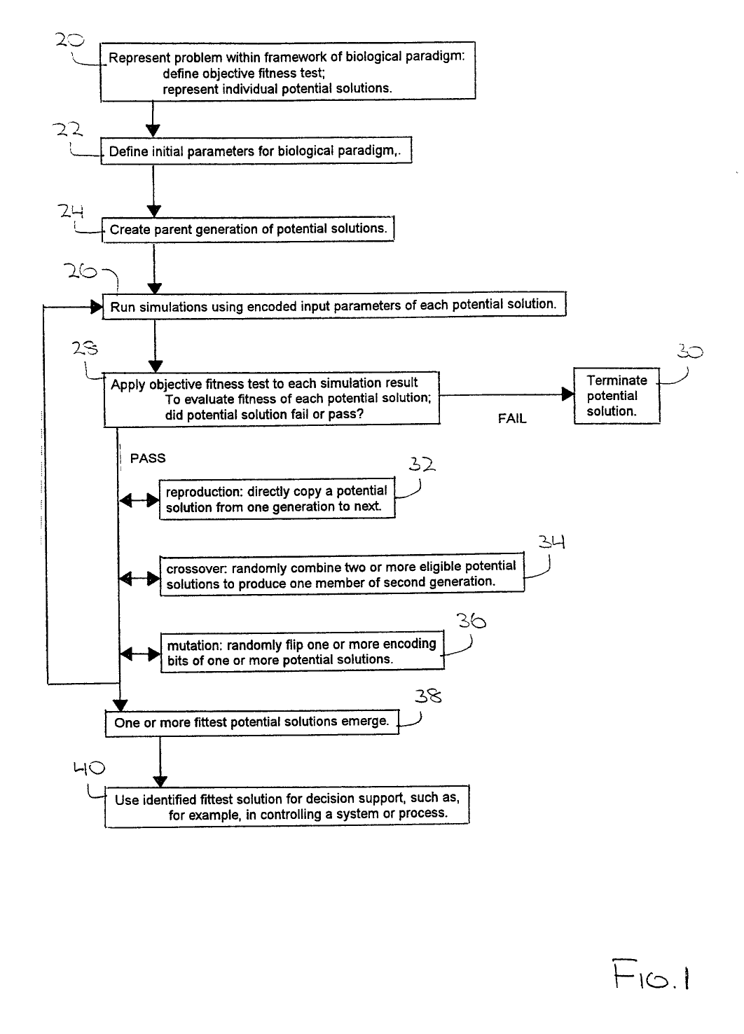

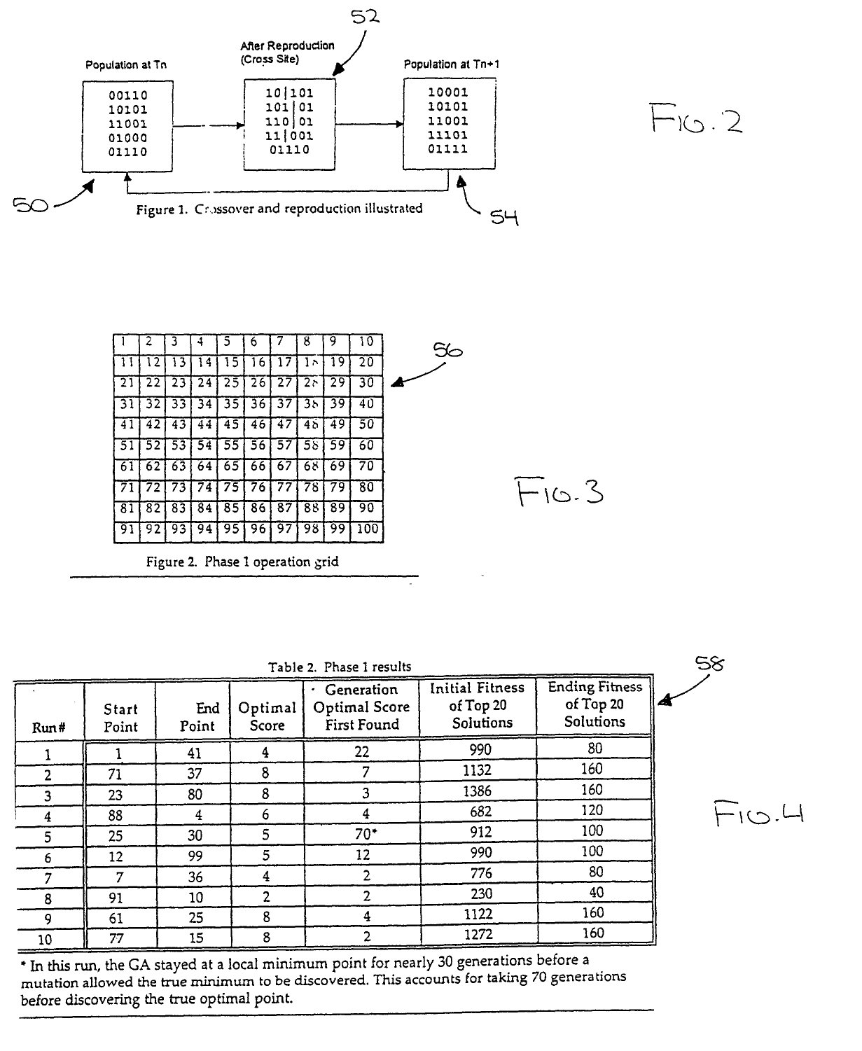

In more detail, referring to FIG. 1, development of the biological paradigm begins with representing the problem within the framework of the paradigm by defining the objective fitness test for evaluating potential solutions, and devising a method for representing individual potential solutions in the computer, as depicted in box 20. The objective fitness test may be based on feasible solution boundaries, such as, for example, maximum acceptable cost or maximum acceptable travel distance, such that any potential solution outside of those boundaries fails the test. Individual potential solutions may be represented in the computer as a data structure, such as a string or array, of single or multi-bit binary encoded input parameters. The nature and number of input parameters and the number of bits needed to encode them are matters of design and will depend upon such variables as the particular system or process being simulated and the nature of the problem to be solved.

Next, as depicted in box 22, the user must define control parameters for controlling functioning of the biological paradigm. Control parameters may include, for example, the size of the pool or population of potential solutions, maximum number of generations, rules for propagating each generation, and whether the paradigm will be clock or event driven. Because these control parameter values may require modification as more is learned about the dynamics of the system, care must be exercised to ensure changes can be easily made.

The parent generation of potential solutions is then created, as depicted in box 24, and simulations run using the encoded input parameters of each potential solution, as depicted in box 26. Each simulation run will produce a simulation result associated with a particular potential solution. The objective fitness test is then applied to each simulation result to evaluate the fitness of each potential solution, as depicted in box 28. If the potential solution fails the test, it is terminated, as depicted in box 30. If no solution passes the test, the control parameters may need to be changed and the process repeated.

If the potential solution passes the test it is deemed eligible to propagate. Using these solutions, the concepts of reproduction, crossover, and mutation are employed to produce the child generation of potential solutions. Reproduction and crossover are the driving forces behind continual improvement of the population of potential solutions; both are illustrated in FIG. 2, wherein a parent generation, depicted in box 50, is shown undergoing reproduction and crossover, depicted in box 52, to result in a child generation, depicted in box 54. Mutation, it will be appreciated, allows broader exploration for new solutions. Returning to FIG. 1, reproduction involves directly copying a potential solution from one generation to the next, as depicted in box 32. As depicted in box 34, crossover involves randomly combining portions of two or more eligible potential solutions to produce a single member of the child generation, much like the DNA-encoded genes of human parents combine to produce a child. As depicted in box 36, mutation involves randomly flipping one or more encoding bits of one or more potential solutions.

The process then repeats itself using the child generation in place of the parent generation, resulting in creation of subsequent generations, until the defined maximum number of generations is reached. Ultimately, one or more fittest solutions will emerge, as depicted in box 38, which may be used for decision support, such as, for example, in controlling a system or process, as depicted in box 40.

In a first preferred embodiment, the discrete event computer simulation is constructed along with and incorporates the biological paradigm. As mentioned, discrete event computer simulation is well-known.

In a second preferred embodiment, the biological paradigm is provided in generic form fully compatible with standard discrete event computer simulations and adapted to facilitate easy integration therewith. Thus, a third-party, having devised a discrete event computer simulation for investigating potential solutions to a particular problem, can obtain and easily integrate the generic biological paradigm to enhance the simulation with an ability to devise solutions as well as test them. The third-party need only provide control parameters for controlling functioning of the paradigm, and input parameters defining the particular model. For example, where the problem involves control and navigation of an automated vehicle from one point to another within a factory, as in Example 1, set forth below, the control parameters may include maximum number of generations and rules for propagation, and the input parameters may include layout of the factory floor, possible paths available, and locations of obstacles.

Generally, uses for the present invention include a programming language preprocessor; a simulation language preprocessor; and an embedded component providing decision support for controlling a system or process. The programming language preprocessor embodiment can be developed using any suitable programming language, including Java, C, C++, or FORTRAN. The programming language-based biological paradigm is used to generate a database that provides input to the computer simulation. Potential uses for the preprocessor include, for example, development of job shop schedules used to drive a model, airport runway allocations, human decision-making based upon a set of known criteria, classroom scheduling, and bus routing.

Similarly, the simulation language preprocessor embodiment can be developed using any suitable simulation language as an implementation medium for a preprocessor. The simulation language-based biological paradigm is used to generate a database that provides input to the model. Example 1, set forth below, is an illustrative example of the simulation language preprocessor embodiment wherein the present invention is used to find the shortest distance between two points.

The embedded component embodiment takes the simulation-based biological paradigm preprocessor a step farther by embedding code in a broader-scale simulation model. This code is used to generate data items on an as-needed basis. When a particular decision based upon a set of stochastically-generated circumstances within the model is required, the biological paradigm is called into action. Example 2, set forth below, is an illustrative example of the embedded component embodiment wherein the present invention is used to provide guidance for controlling the movement of a guided vehicle through a factory. It will be appreciated that Example 2 involves a practical application of the concepts disclosed in Example 1.

Examples 1 and 2 were implemented using the GPSS/H Professional simulation software package for the personal computer (PC), which provides a high speed, 32 bit language well-suited for a CPU intensive project. As noted, however, any suitable simulation language may be used.

### EXAMPLE 1

### Shortest Path Determination

In a first illustrative example, the present invention was used to determine the shortest path between two points in an interconnected one hundred point operation grid 56 (see FIG. 3). This exemplary simulation language-based preprocessor application is a logical starting point for and is readily adaptable to more complex applications using the same general concepts.

In this example, boundaries for feasible solutions included any route that could be completed within allowable limits of simulated time. This then formed the basis for the objective fitness test.

Each potential solution of the parent generation was encoded as a string of binary bits operable to act as a roadmap for guiding movement. Each move was encoded as two binary digits where 00=left, 10=right, 01=up, and 11=down. If diagonal moves were desired in this system, the binary encoding scheme commands could have been expanded to a three bit format. Although shown in FIG. 3 as a two-dimensional grid, the system operated in three dimensional hyperspace with the edges of the grid wrapping around to points on opposite sides. Thus, movement from point 10 to point 1 or from point 10 to point 9 both involved the same distance and could be accomplished in the same number of time units. When the pre-selected destination was reached, the string creature was removed from the system and total time used to reach the destination was tabulated.

Because each string creature had a starting point and a desired ending point in the grid, either travel time or distance could be tabulated. The objective fitness function was implemented seeking to minimize the total travel time or distance. Thus, string creatures that found the destination point faster were rewarded with a higher probability of survival; those wandering about the grid without arriving at the desired destination were more likely to be terminated without propagating. Overtime, average population travel times were expected to approach a minimum. To facilitate movement toward this minimum, strategies for population size, selection, reproduction, crossover, and mutation were selected.

An eight step procedure known in the art was used to ensure all aspects of the biological paradigm development were considered. These steps were adapted for use in selecting control parameter values. First, the generation counter was initialized to zero, so i=0. Next, the initial population P(i) was created by generating a set of N random potential solutions. In the current example, N=50. In general, smaller population size reduces processing time required to arrive at a solution. Next, the fitness of each potential solution was determined by evaluating the solution in light of the object fitness test. The generation counter was then incremented, so i=i+1.

Next, a new generation population, P(i), was created using a multi-step process, involving first selecting n individuals stochastically based on the fitness of the prior population, P(i−1). In the present example, the top five most successful string creatures were selected by default, and additional string creatures were stochastically chosen by ranking their fitness scores and assigning a higher probability of survival to the better, higher-ranked solutions. Parents (members of the P(i−1) generation) were then randomly paired to produce children (members of the P(i) generation). Crossover points were randomly chosen for exchanging binary material between parents. Particular bits were randomly mutated. In the present example, a relatively high mutation rate of 0.05 was applied.

Once the new population had been created, and the maximum number of generations N had not been exceeded, the process repeated itself, starting with determining the fitness of the current generation. If the maximum number of generations had been reached, results would be reported.

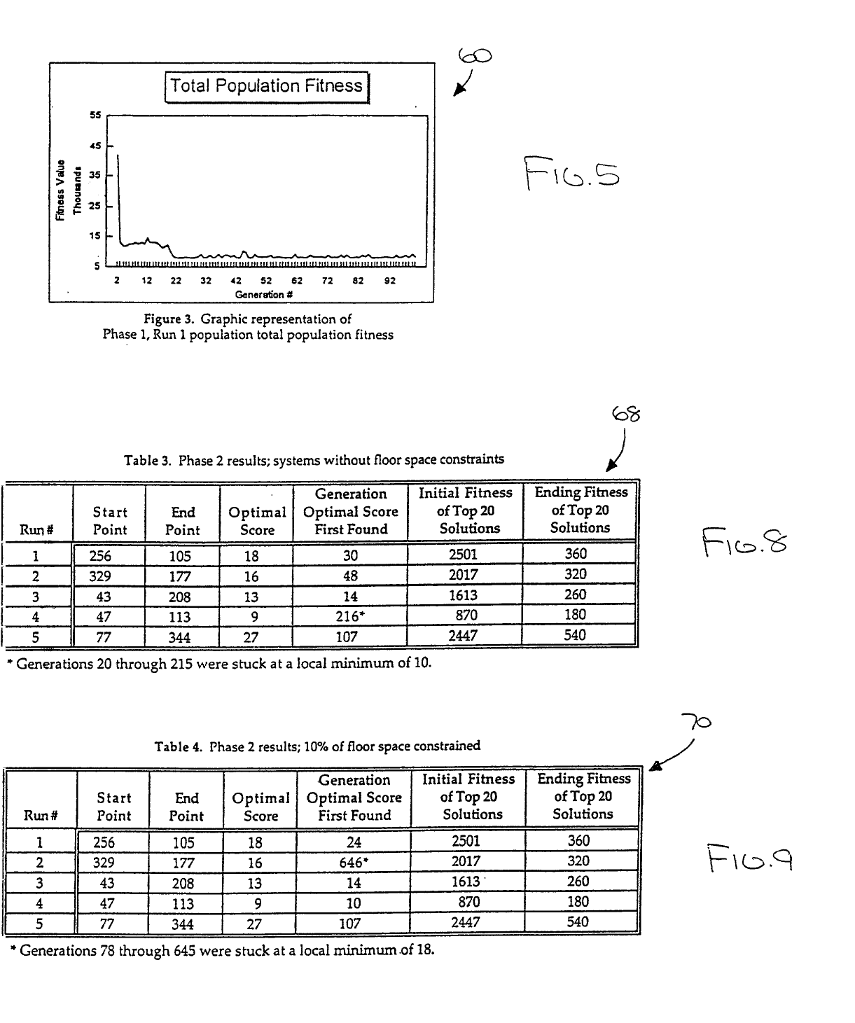

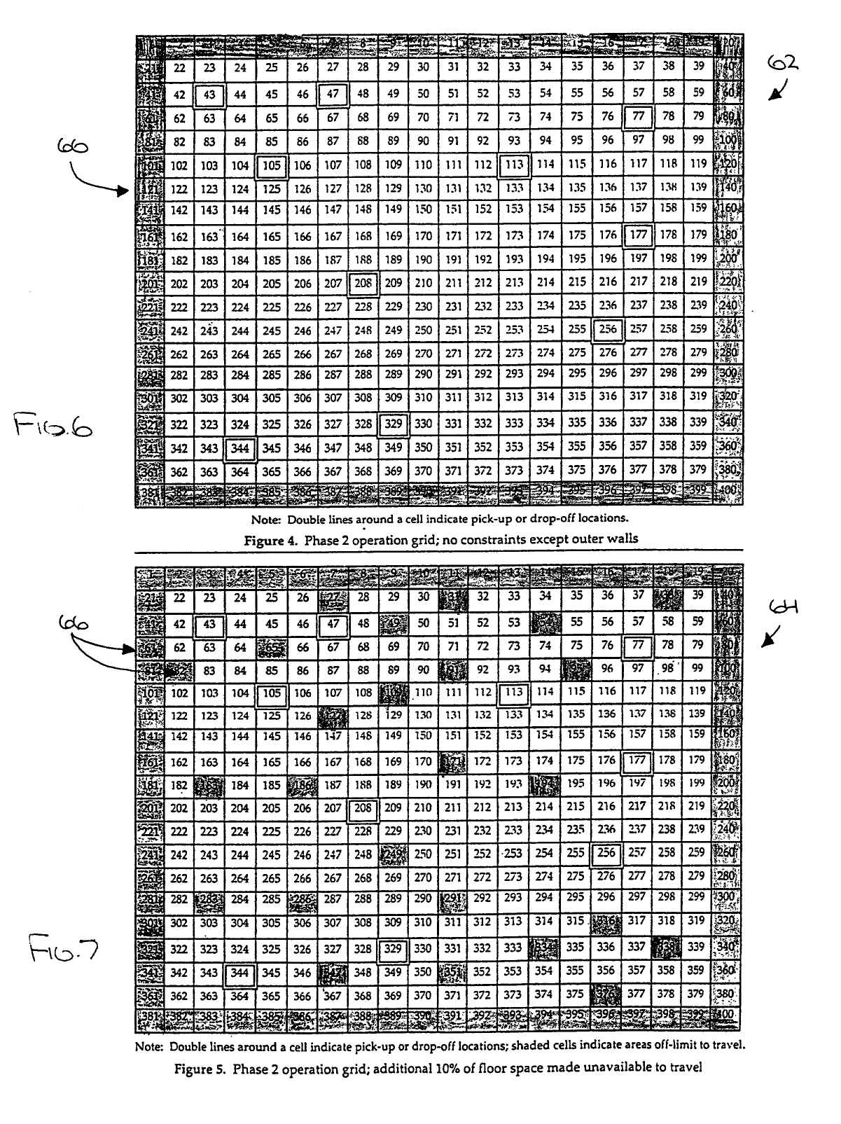

Referring to FIG. 4, a data table 58 is shown setting forth data collected over a subset of ten trips, each having a randomly assigned starting point and destination. The string creatures representing potential solution were placed in the system at their starting locations and allowed to “learn” the most efficient routes to their destinations. For each trip, a variety of statistics were collected, including average fitness (based on the top twenty solutions) at start and finish, and the generation wherein an optimal solution was first discovered. FIG. 5 shows a graph 60 illustrating progression over the generations toward an optimal solution. The optimal solution was manually calculated prior to the trip and used for comparison to validate the solution identified as optimal by the biological paradigm. Identified optimal solutions for various starting and destination points were stored in a table for later access and use by a system or process requiring decision support.

In some cases, local minimums caused the system to stabilize at a non-optimal point for a substantial number of generations before a mutation produced a better solution. In general, as applications become more complex, the likelihood of finding a local minimum increases, meaning the biological paradigm may need to run for longer periods of time or with larger populations. It is also possible to detect and avoid local minimums using the pseudo-random number streams used by the biological paradigm to make stochastic decisions.

### EXAMPLE 2

### Free-Ranging Automated Guided Vehicle Control

In a second illustrative example, the present invention was used as an embedded component to provide decision support for guiding or navigating a free-ranging automated guided vehicle.

Traditionally, automated guided vehicles have been used to transport material in support of warehousing, manufacturing, and service systems. These vehicles are typically battery-powered, driverless, and controlled by a central computer or by distributed local controls such as programmable logic controllers. While automated guided vehicles typically travel on paths of energized buried wire or chemical trails, free-ranging automated guided vehicles rely on maps programmed into the vehicle's microprocessor memory and sensors for detecting obstructions and calculating position. A common goal for both types of vehicle systems is to optimize vehicle usage by selecting efficient paths between material pick-up and delivery points, wherein the paths involve clearly defined routes that rarely vary.

For the free-ranging automated guided vehicles of the present example, available paths changed frequently due to placement of material, boxes, or other obstacles in potential paths. In a simulation of this system, a database with several different routes between pick-ups and deliveries could be created in much the same way a traditional automated guided vehicle route database is created. However, route selection between points would require episodic modification to represent environmental changes that cause vehicles to take different paths.

A biological paradigm-based autonomous guided vehicle simulation offered a better method of representing changes to traffic flow. Instead of representing the system as a series of paths and intersections, the factory was represented as a grid, where each grid point corresponded to the physical space required by a single vehicle. Each point was indicated to be either clear and available for travel or occupied by material and unavailable for travel. As points on the grid became available or unavailable, the biological paradigm was used by each vehicle to learn a new route. The learned information was then made available to the vehicle control as a binary roadmap to facilitate navigation.

A biological paradigm-based approach could have been be used in at least two ways to solve this problem. In a first approach, the system state could be set prior to a model run and the biological paradigm used to calculate all routes, which could then have been stored in a database of binary maps. Thereafter, the vehicles could index into the database to retrieve an appropriate map. This first approach would have reduced the dynamic capability of the model to experience environmental changes during the course of each run. A major assumption was that available locations in the grid remain available throughout the entire model run. The major advantage to this approach was runtime speed; paths were initially calculated and then loaded into a database which could be used by the vehicles as the subsequent portion of the model runs.

The second approach was to use the biological paradigm “on-the-fly”. This means at the time a vehicle was assigned a trip, a biological paradigm would have been called to learn the best path for completing the trip under the current system state. Thus, the biological paradigm could have been used to learn a specific route any time the system state changed in a way that could have affected the route. While this approach would have allowed operation to be more dynamic, it would have slowed the model considerably and complicated the model code.

As this practical application example is substantially related to the previous example, the same methods of representing the problem and objective functions could be employed. In this scenario, however, both the unobstructed grid 62 and the obstructed grid 64 were 20 by 20 (see FIGS. 6,7), yielding 400 interconnected points. Shaded grid squares 66 indicate outer factory walls in both grids 62,64, as well as floor space unavailable to travel in the obstructed grid 64. The initial population, P(i), was set to 200, which, being a relatively small number, reduced processing time. The maximum time a string creature was allowed to search for the destination was limited to 125 time units. For subsequent generations, the top 20 most successful string creatures were selected by default and additional string creatures were stochastically chosen by ranking scores and assigning a higher probability of survival to the better solutions. Parent pairings and crossover points were randomly selected; and a relatively high mutation rate of 0.03 was selected. A mechanism was built into the simulation model to allow the string characters to detect if a point was unavailable for travel, being occupied or otherwise off limits.

As in the previous example, string creatures representing potential solutions were encoded using binary data structures which could act as maps to guide movement. The same movement coding scheme was used. Also, as in the previous example, when a potential solution reached a predesignated destination, that solution was removed from the system and the total time or distance required to reach the destination was tabulated. The solution's binary map could thereafter be used in the autonomous guided vehicle simulation.

In each scenario starting points were assigned randomly, the only condition being that no starting point or destination could be in an off-limits square. The program was tested with two different scenarios, the first scenario used the unobstructed operation grid 62 shown in FIG. 6, constrained only by the outer walls of the factory, indicated by shaded grid squares 66. The results of this first scenario are shown in the data table 68 of FIG. 8. The second scenario used the obstructed operation grid 64 shown in FIG. 7 wherein 10% of the factory floor space was made unavailable to travel, also indicated by shaded grid squares 66. The results of this second test are shown in the data table 70 of FIG. 9. The data tables 68,70 of FIGS. 8 and 9 show each run's starting point and destination point, manually calculated optimal score, generation the optimal score was first found, and average initial and ending fitness of the top twenty potential solutions. In all runs of both scenarios, population fitness improved dramatically overtime and optimal solutions were ultimately discovered.

The fittest binary encoded potential solutions were then stored in a table for subsequent use as maps or navigation aids for the autonomous guided vehicles. By matching given starting and destination points with those stored in the table, the vehicles were able to identify and use the corresponding optimal solution to control movement through the factory. Alternatively, as mentioned, the vehicle could have used the algorithm “on the fly”, thereby eliminating the table of stored solutions and determining optimal solutions only as needed for particular star and destination points.

From the preceding description, it will be appreciated that the present invention, a computer program for and method of discrete event computer simulation incorporating a biological paradigm, provides a distinct advance in the art of decision support tools, being able to both devise and test potential solutions to a given problem.

Although the invention has been described with reference to the preferred embodiment illustrated in the attached drawings, it is noted that equivalents may be employed and substitutions made herein without departing from the scope of the invention as recited in the claims. For example, the present invention is independent of any particular discrete event computer simulation or model or algorithm for generating such, all of which are well-known in the art. The present invention is also independent of any particular biological paradigm or algorithm for generating such, though a preferred method is described herein. The present invention is also independent of any implementing language, storing memory, or executing system, though, again, preferences are set forth herein.

Having thus described the preferred embodiment of the invention, what is claimed as new and desired to be protected by Letters Patent includes the following:

1. A computer program for facilitating decision making, the computer program being stored in a computer-readable memory and executable by a computing device, the computer program comprising:
a code segment operable to perform discrete event computer simulation for testing one or more encoded potential solutions by modeling a system wherein any changes take place substantially instantaneously and in countable increments in response to discrete events; and
a code segment operable to provide a biological paradigm involving the creation, evaluation, and propagation of a population of the encoded potential solutions,
wherein the computer program is operable to both devise and test one or more of the encoded potential solutions.

2. The computer program as set forth in claim 1, wherein creating, evaluating, and propagating the population of encoded potential solutions involves:
a code segment for evaluating a fitness parameter of each of the encoded potential solutions using an objective fitness test;
a code segment for terminating any of the encoded potential solutions that fail the objective fitness test;
a code segment for propagating any of the remaining encoded potential solutions to produce a second population of encoded potential solutions.

3. The program as set forth in claim 2, wherein propagating any remaining encoded potential solutions involves—
combining two or more of the remaining encoded potential solutions to produce a single member of the second population of encoded potential solutions; and
introducing random change into the population of encoded second potential solutions by randomly changing the encoding of one or more encoded potential solutions.

4. The computer program as set forth in claim 1, wherein the computer program is used as a simulation language preprocessor.

5. The computer program as set forth in claim 1, wherein the computer program is used as an embedded component operable to provide decision support for controlling a system and a process.

6. A computer program for facilitating decision making, the computer program being stored in a computer-readable memory and executable by a computing device, the computer program being operable to perform discrete event computer simulation for testing one or more encoded potential solutions by modeling a system wherein any changes take place substantially instantaneously and in countable increments in response to discrete events, the computer program comprising:
a first code segment for creating a population of encoded first potential solutions;
a second code segment for performing an evaluation of a fitness level of each encoded first potential solution, and for producing a fitness result representative of the evaluation;
a third code segment for terminating one or more of the encoded first potential solutions based upon the fitness result;
a fourth code segment for propagating any remaining encoded first potential solutions to create a population of encoded second potential solutions, the code segment for propagating including—
a fourth_{A} code segment for combining two or more of the remaining encoded first potential solutions to produce a single member of the population of encoded second potential solutions, and
a fourth_{B} code segment for introducing random change into the population of encoded second potential solutions by randomly changing the encoding of one or more encoded second potential solutions; and
a fifth code segment for reporting one or more fittest encoded potential solutions.

7. The computer program as set forth in claim 6, wherein each of the encoded first and second potential solutions comprise one or more input parameters, with each input parameter being encoded in a data structure using one or more bits.

8. The computer program as set forth in claim 7, wherein the fourth_{B} code segment involves randomly flipping one or more bits of one or more encoded second potential solutions.

9. The computer program as set forth in claim 6, wherein the computer program is used as a simulation language preprocessor.

10. The computer program as set forth in claim 7, wherein the computer program is used as an embedded component operable to provide decision support for controlling a system and a process.

11. A method of facilitating decision making, the method comprising the steps of:
(a) creating a discrete event simulation for testing one or more encoded potential solutions by modeling a system wherein any changes take place substantially instantaneously and in countable increments in response to discrete events;
(b) incorporating a biological paradigm into the discrete event simulation;
(c) creating, evaluating, and propagating a population of the encoded potential solutions; and
(d) reporting one or more identified fittest potential solutions.

12. The method as set forth in claim 11, wherein step (c) includes the substeps of—
(c₁) evaluating each encoded potential solution with an objective fitness test;
(c₂) terminating any encoded potential solutions that fail the objective fitness test; and
(C₃) propagating any remaining encoded potential solutions to produce a population of encoded second potential solutions.

13. The method as set forth in claim 12, wherein substep (C₃) of step (c) further includes the substeps of—
(C_{3.1}) combining two or more of the remaining encoded potential solutions to produce a single member of the population of encoded second potential solutions; and
(c_{3.2}) introducing random change into the population of encoded second potential solutions by randomly changing the encoding of one or more encoded second potential solutions.

14. The method as set forth in claim 11, wherein the method is used to provide a simulation language preprocessor.

15. The method as set forth in claim 11, wherein the method is used to provide an embedded component operable to decision support for controlling a system and a process.

16. A method of facilitating decision making, the method comprising the steps of:
(a) creating a discrete event simulation for testing one or more encoded potential solutions by modeling a system wherein any changes take place substantially instantaneously and in countable increments in response to discrete events;
(b) incorporating a biological paradigm into the discrete event simulation,
(c) creating a population of encoded first potential solutions;
(d) evaluating each encoded first potential solution using an objective fitness test;
(e) terminating any encoded first potential solutions that fail the objective fitness test;
(f) propagating any remaining encoded parent potential solutions to produce a population of encoded second potential solutions;
(g) repeating steps (d)-(f), wherein in each repetition the population of encoded second potential solutions replaces the population of encoded first potential solutions; and
(f) identifying and reporting one or more fittest potential solutions.

17. The method as set forth in claim 16, wherein step (f) includes combining two or more of the remaining encoded first potential solutions to produce a single member of the population of encoded second potential solutions.

18. The method as set forth in claim 16, wherein step (f) includes introducing randomness into the population of encoded second potential solutions by randomly changing the encoding of one or more of the encoded second potential solutions.

19. The method as set forth in claim 16, wherein the method is used to provide a simulation language preprocessor.

20. The method as set forth in claim 16, wherein the method is used to provide an embedded component operable to provide decision support for controlling a system and a process.
